(19) United States
(12) Patent Application Publication
(10) Pub. No.: US 2013/0249874 A1
(43) Pub. Date: Sep. 26, 2013

(54) METHOD AND SYSTEM FOR 3D DISPLAY WITH ADAPTIVE DISPARITY

(71) Applicants: Jianping Song, Beijing (CN); Wen Juan Song, Beijing (CN); Yan Xu, Beijing (CN)

(72) Inventors: Jianping Song, Beijing (CN); Wen Juan Song, Beijing (CN); Yan Xu, Beijing (CN)

(73) Assignee: THOMSON LICENSING, Issy de Moulineaux (FR)

(21) Appl. No.: 13/991,627

(22) PCT Filed: Dec. 8, 2010
(86) PCT No.: PCT/CN2010/001988

§ 371 Date: Jun. 5, 2013

(51) Int. Cl. H04N 13/00

(52) U.S. Cl. CPC H04N 13/0022
USPC 345/204

(57) ABSTRACT

An image processing apparatus and a method are proposed to control the disparity and rate of disparity change in a 3D image. The method includes the following steps: inputting a maximum negative disparity threshold value and/or a maximum rate threshold value of disparity change by a viewer; receiving data of a 3D image; decoding the data into left eye image data and right eye image data; determining a maximum negative disparity and a rate of disparity change of the decoded 3D image data; determining and image movement value based on the determined maximum negative disparity and rate of disparity change and at least one threshold value; adjusting the left eye image and the right eye image using the image movement value; and displaying the adjusted left eye image and right eye image to a viewer on a 3D display device. The apparatus comprises image receiver, image decoder maximum disparity analyzer disparity control value determiner, user interface, disparity adjuster, and stereo display.

### FIELD

The present invention is related to three dimensional display systems, in particular, the invention relates to a method and system for adjusting the disparity of an input 3D image for display.

### BACKGROUND

Binocular vision provides humans with the advantage of depth perception derived from the small differences in the location of homologous, or corresponding, points in the two images incident on the retina of the two eyes. This is known as stereopsis (meaning solid view) and can provide precise information on the depth relationships of objects in a scene. The difference in the location of a point in the left and right retinal images is known as disparity.

Conventional three dimensional (3D) displays produce a 3D image by projecting images having different disparities to the left and right eyes of a user using a 2D flat display and by using tools such as a polarizer glass or a parallax barrier. To produce a 3D image, a real image is filmed by a 3D camera. Alternatively, 3D image contents may be produced using computer graphics.

Although the objective is to make sure that each eye sees the same thing it would see in nature, no flat display device, whether 2D or 3D, duplicates the way in which human eyes actually function. In a 2D display, both eyes are looking at the same, single, image instead of the two parallax views. In addition, in most images, the whole scene is in focus at the same time. This is not the way our eyes work in nature, but our eyes use this whole scene focus technique so that we can look wherever we want on the display surface. In reality, only a very small, central, part of our field of view is in sharp focus, and then only at the fixation (focus) distance. Our eyes continually change focus, or accommodate, as we look at near and far objects. However, when viewing a (flat) 2D image, all the objects are in focus at the same time.

In stereoscopic 3D displays, our eyes are now each given their proper parallax view, but the eyes still must accommodate the fact that both images are, in reality, displayed on a flat surface. The two images are superimposed on some plane at a fixed distance from the viewer, and this is where he or she must focus to see the images clearly. As in real nature, our eyes roam around the scene on the monitor and fixate on certain objects or object points. Now, however, our eyes are converging at one distance and focusing at another. There is a “mismatch” between ocular convergence and accommodation. Convergence is the simultaneous inward movement of both eyes toward each other, usually in an effort to maintain single binocular vision when viewing an object.

In FIG. 1, for example, suppose that the left eye 102A and the right eye 102B views are converged at a object, “F”, at 10 ft, and a near object, “A”, is 5 ft away and a far object, “B”, is at 15 ft. Objects at the convergence distance do not have any disparity and appear exactly overlaid on the screen 104. In the 3D space surrounding the display screen 104, objects appear to reside on the screen 104 surface. Object A, which appears to be in front of the screen 104, is said to have negative disparity. This negative disparity can be measured as a distance 106 on the screen 104 surface. An object B, which appears to be behind the screen 104, has positive disparity. This positive disparity can be measured as a distance 108 on the screen 104 surface. In order to view object A, our eyes converge to a point that is in front of the screen 104. For object B, the convergence point is behind the screen 104. As in real nature, our eyes converge on the various objects in the scene, but they remain focused on the display of the flat screen 104. Thus we are learning a new way of “seeing” when we view stereo pairs of images. When the two images match well and are seen distinctly and separately by the two eyes, it becomes easy to fuse objects. Fusing is the process of human brain to mix the left view and the right view with disparity into a 3D view. By way of explanation, binocular vision fusion occurs when both eyes are used together to perceive a single image despite each eye having its own image. Binocular vision fusing is easy even if there is a little amount of horizontal disparity in the right and left eye images. However, when we view images having large disparity for a long time, we may easily become fatigued and may have side effects, such as nausea. Also, some people may find that it is difficult, or even impossible, to fuse objects if there is a large negative amount of disparity.

When people watch 3D images, they encounter eye fatigue issues if objects protrude from the screen too much. Moreover, many people can't fuse the object if the object protrudes from the screen too quickly.

### SUMMARY

The present invention solves the foregoing problem by providing a method and system which can be used to reduce eye fatigue and help people fuse objects more easily. In one embodiment, a method can be used to control convergence of an image by adjusting the disparity of the image at a receiving end which receives and displays a 3D image as well as by adjusting the rate of change of disparity. A threshold value of the maximum negative disparity is set by users. In one mode, when the maximum disparity of any objects of a 3D image exceeds the threshold value, the disparity of the 3D image is adjusted so that it will not exceed the threshold. In another embodiment, when the maximum disparity of any objects of a 3D image exceeds the threshold value, the rate of the change of the disparity is adjusted so that the rate will not exceed a predetermined value.

Additional features and advantages of the invention will be made apparent from the following detailed description of illustrative embodiments which proceeds with reference to the accompanying figures.

### BRIEF DESCRIPTION OF THE DRAWINGS

FIG. 1 illustrates an example of disparity in 3D systems;

FIG. 2A illustrates an example of a left eye image;

FIG. 2B illustrates an example of a right eye image;

FIG. 2C represents an overlay of images from FIGS. 2A and 2B;

FIG. 3A illustrates an example method of reducing disparity in a left eye image according to an aspect of the invention;

FIG. 3B illustrates an example method of reducing disparity in a right eye image according to an aspect of the invention;

FIG. 3C illustrates an overlay of the examples of FIGS. 3A and 3B to reduce disparity according to an aspect of the invention;

FIG. 4 illustrates an example block diagram which implements the method of the invention; and

FIG. 5 illustrates an example method according to aspects of the invention.

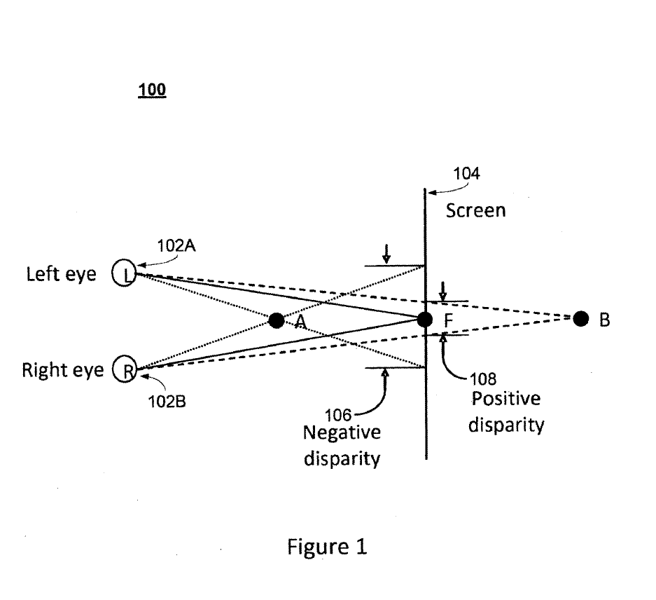

### DETAILED DISCUSSION OF THE EMBODIMENTS

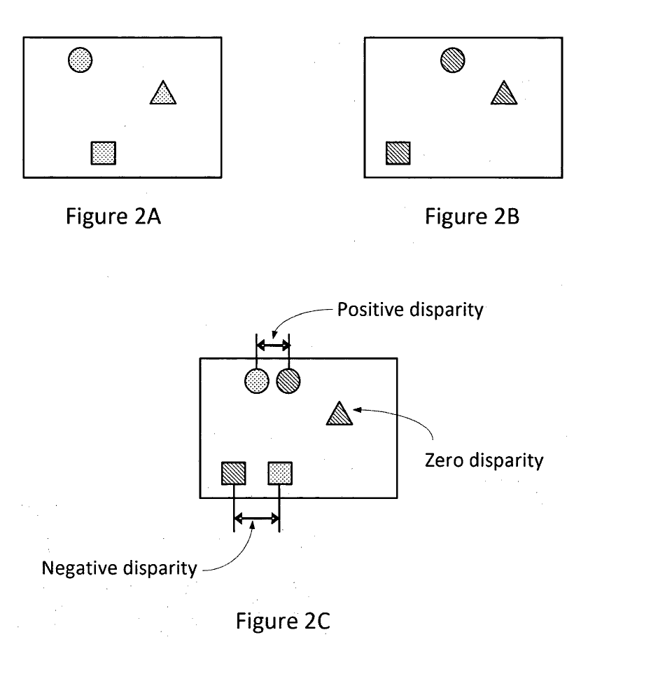

FIG. 2A and FIG. 2B illustrate a left-eye image and a right-eye image, respectively, filmed or recorded by a parallel stereo-view or multi-view camera. FIG. 2C illustrates the left-eye image of FIG. 2A superimposed on the right-eye image of FIG. 2B in one plane to present a disparity between them. It is assumed that positive disparity exists when objects of the right-eye image exist on the right side of identical objects of the left-eye image. Similarly, negative disparity exists when an object of the left eye image is to the right of the right eye image. As shown in FIG. 2C, the circular object has positive disparity, meaning that it is perceived by a viewer to be away from the viewer and sunk into the screen. The square object has negative disparity, meaning that it is perceived to be closer to the viewer and in front of or popping out of the screen. The triangular object has zero disparity, meaning that it seems to be at the same depth as the screen. In a stereo image, negative disparity has a larger 3D effect than positive disparity, but a viewer is more comfortable with positive disparity. However, when an object in the stereo image has excessive disparity to maximize the 3D effect, side effects arise, such as visual fatigue or fusion difficulty.

It is known to the skilled in the art that the maximum fusion range is within ±7° parallax, a range for reasonable viewing is within ±2° parallax, and a range for comfortable viewing is within ±1° parallax. Therefore, the disparity of a stereo image must be in at least a reasonable range. However, such a range of disparity may differ according to individual differences, display characteristics, viewing distances, and contents. For example, when watching the same stereo image on the same screen at the same viewing distance, an adult may feel comfortable while a child may find it difficult to fuse the image. An image displayed on a larger display than originally intended could exceed comfortable fusion limits or give a false impression of depth. It may be difficult to anticipate the individual differences, screen size or viewing distances when the stereo image is filmed by 3D camera. Therefore, the disparity of stereo-image is advantageously processed in the receiving terminal before it is displayed.

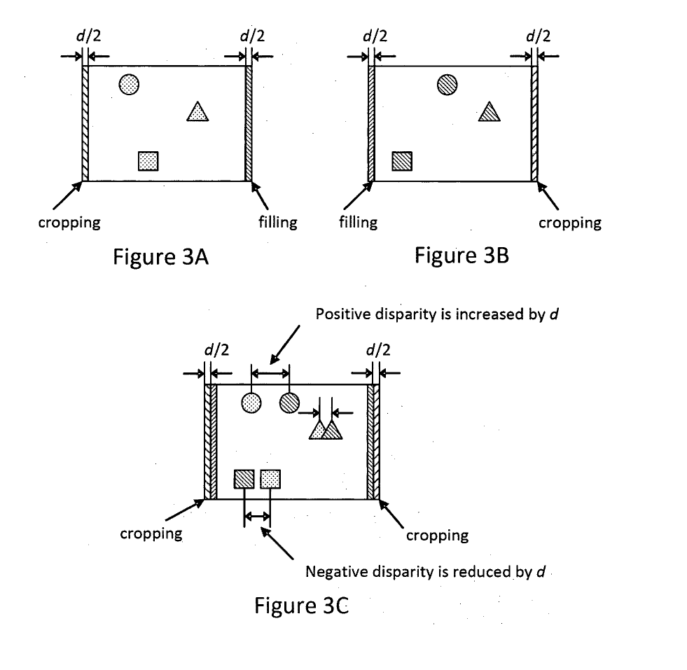

Although negative disparity has a larger 3D effect than positive disparity, it is more difficult for a viewer to fuse an object with a negative disparity than that with a positive disparity. Referring to FIG. 2C, the square object has a large negative disparity, which may exceed one's fusion limit. Note that in FIG. 2C, the square right eye image is to the left of the left eye image. FIGS. 3A-3C illustrate a process of reducing the negative disparity of a stereo image by moving the left-eye image and the right-eye image of FIGS. 2A-2C to the left and right, respectively, according to an embodiment of the present invention. In other words, FIGS. 3A-3C illustrate a method of processing an image to provide a stable 3D image to users by adjusting disparities. FIG. 3A illustrates the left-eye image in FIG. 2A moved to the left by cutting off (cropping) the left end of the image by a distance d/2 and then filling the right end of the image by a distance of d/2. FIG. 3B illustrates the right-eye image in FIG. 2B moved to the right by cutting off (cropping) the right end of the image by a distance d/2 and then filling the left end of the image by a distance of d/2. FIG. 3C illustrates the right-eye image in FIG. 3A synthesized with the left-eye image in FIG. 3B on a 3D stereo display according to an embodiment of the present invention. Note that the overall effect of cropping and filling of the individual images has a net zero effect on the overall size of the image, but that the relative disparities are changed by a distance d in the synthesis of FIG. 3C.

Referring to FIG. 3C, the disparity of the square object is reduced by d (that is, the disparity value is increased (made less negative) by d), compared with that of the square object illustrated in FIG. 2C. Therefore, the square object appears to protrude less from the screen and a viewer finds it easier to fuse the binocular view of the image of the square object. Note that not only for the square object but also for all the objects of the image, the values of the disparity are changed by d. Therefore, all the objects of the image on the screen seem to become farther away from the viewer. In other words, all the objects seem to be inclined to sink into the screen. For example, the circular object seems to be sunk more into the screen, and the triangular object, which seems to be at the same depth as the screen before adjusting disparities, now seems to be sunk into the screen. It's possible that some of the objects may shift from protruding from the screen to sinking into the screen after the disparity adjustment of the present invention.

Contrarily, if we want to enhance the 3D effect and make all objects near the viewer, we can decrease the disparity of the stereo image by moving the left-eye image to the right and moving the right-eye image to the left.

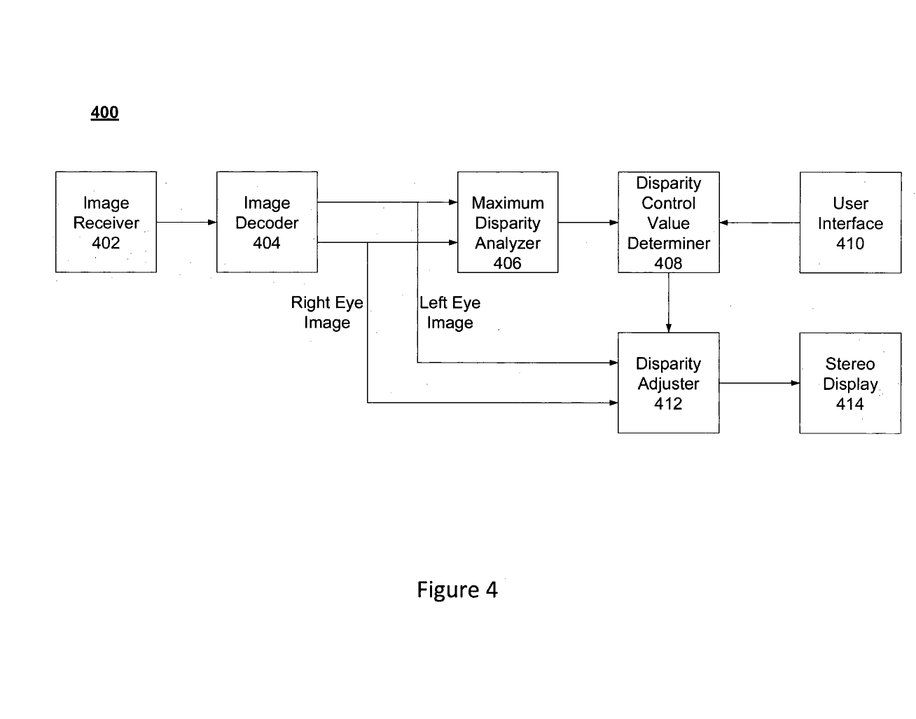

FIG. 4 is a block diagram of an image processing system 400 according to an embodiment of the present invention. Referring to FIG. 4, the image processing system includes an image receiver 402, an image decoder 404, a maximum disparity analyzer 406, a disparity control value determiner 408, a disparity adjuster 412, a user interface 410, and a 3D stereo display 414. Briefly, a viewer can interactively use the system 400 via the user interface 410 to allow the disparity control value determiner 408 to adjust the disparity adjuster 412 so that the user (viewer) can comfortably view 3D images presented by the stereo 3D display 414. Initially, the viewer interactively uses the user interface 410 to determine a maximum comfortable disparity value (a maximum negative disparity threshold value) and a comfortable disparity change rate (a maximum protruding rate threshold value). The maximum protruding rate threshold value is a value set by a user interaction to limit the speed of change of an object with negative disparity, i.e. an object popping out of a 3D display screen. Without the present system; a user of the stereo display 414 may have an uncomfortable viewing session if the 3D images presented to the viewer exceed a maximum negative disparity threshold value. By utilizing the user interface, the user is able to adjust the 3D image to certain disparity values that are more comfortable for the individual viewer or group of viewers. The more comfortable viewing session for the user results from an adjustment of disparity to limit not only a maximum negative disparity but also to limit the speed at which objects protrude from the viewing screen due to negative disparity.

Returning to FIG. 4, the image receiver 402 receives and transmits stereo-view or multi-view images to the image decoder 404. The image decoder 404 decodes the stereo-view or multi-view image and outputs the left-eye image and right-eye image to the maximum disparity analyzer 406 and the disparity adjuster 412. The maximum disparity analyzer 406 estimates the disparities between the right-eye image and the left-eye image and determines the maximum negative disparity Dm. Those skilled in the art know that many methods can be used to estimate the disparities between two images. The disparity control value determiner 408 receives the determined maximum negative disparity Dm from the maximum disparity analyzer 406 and determines the movement value d for both the left-eye and right-eye images. In detail, the disparity control value determiner 408 compares the amount of the determined maximum negative disparity to a disparity threshold value Dt, which is assumed to be a viewer's maximum negative disparity that the viewer feels is a comfortable value while observing the stereo 3D display 414 (For the purpose of simplification, Dt is the absolute value of a viewer's maximum negative disparity). If the amount of the maximum negative disparity of the received left eye and right eye image is greater than the maximum negative disparity threshold value Dt, a disparity control value is calculated as the image movement value d. In addition, the disparity control value determiner 408 determines a rate of change of disparity based on the current rate of change of disparity in the left and right eye images based on the disparity change between a last 3D image and the present 3D image in comparison to a maximum protruding rate threshold representing a maximum rate of change of disparity determined from the viewer.

As will be appreciated by one of skill in the art, FIG. 4 may be implemented by either a single processor system or a multi-processor system. For example, in a single processor embodiment, a bus based system could be used such that input and output interfaces could include an image receiver 402, a user interface 410, and a disparity adjuster 412 output to drive a stereo display 414. In such a single processor system, the functions performed by the image decoder 404, maximum disparity analyzer 406, disparity control value determiner 408, could be accommodated by a processor operating with memory to perform the functions of the individual functional boxes of FIG. 4. Alternately, some or each of the functional boxes of FIG. 4 can function with an internal processor, memory, and I/O to communicate with their neighboring functional blocks.

In an embodiment of the invention, viewers would use the system 400 of FIG. 4 to prevent objects from protruding too much from the screen of stereo 3D display 414. In this case, the amount of the maximum negative disparity Dm should not exceed the disparity threshold value Dt related to the viewer. Therefore, the image movement value d is simply calculated as

d=|Dm|−Dt if |Dm|>Dt

or

d=0 if |Dm|≦Dt Equation (1)

In another embodiment of the invention, viewers want the 3D effect as great as possible, but they have difficulty in fusing objects that protrude from the screen too much and too quickly. In this case, the amount of the maximum negative disparity Dm should not increase too quickly. Here, in utilizing the user interface 410, a viewer establishes a maximum protruding rate threshold for comfortable user viewing. The image movement value d is calculated as

d=|Dm|−D′−δif |Dm|>D′+δ

or

d=0 if |Dm|≦D′+δ Equation (2)

where δ is a value, determined via use of the user interface 410 and the disparity control value determiner 408, used to control the protruding rate (change of disparity rate), and D′ is the amount of the maximum negative disparity of the last image whose disparity has been adjusted. D′ is set as Dt initially and stored in the disparity control value determiner 408. Once the disparity of an image is adjusted, D′ is updated as

D′=|Dm|−2d Equation (3)

Using the above, not only the maximum disparity can be controlled within a limit that is comfortable to a viewer, but also the rate of a protruding image can be controlled by establishing a viewer's maximum protruding rate threshold and controlling the rate of disparity change between the right and left eye images. In one embodiment, this is accomplished by storing in memory at least a last image disparity value so that a rate can be determined between the last image and a current image and the relative disparity changes (rate of change) between the successive right and left eye image sets received and decoded. Note that one advantage of this embodiment is that only the last image disparity rate value is stored and not the last entire image frame.

Disparity control value determiner 408 receives the disparity threshold value Dt and the protruding rate value δ from a user via inputs from the viewer and the User Interface 410. The disparity adjuster 412 adjusts the disparity of the stereo image by moving the left-eye image to the left and the right-eye image to the right by the image movement value d received from the disparity control value determiner 408, and then outputs the disparity-adjusted left-eye image and right-eye images to the stereo display 414. It will be apparent to those of skill in the art that the left-eye image and the right-eye image need not be moved an equal amount. For example, in one embodiment, the left-eye image may be moved by d while the right-eye image is not moved. Equivalently, other unequal amounts of right eye and left eye movements can be implemented. In one embodiment, the left eye image may be moved by ⅓d, and the right eye image may be moved by ⅔d.

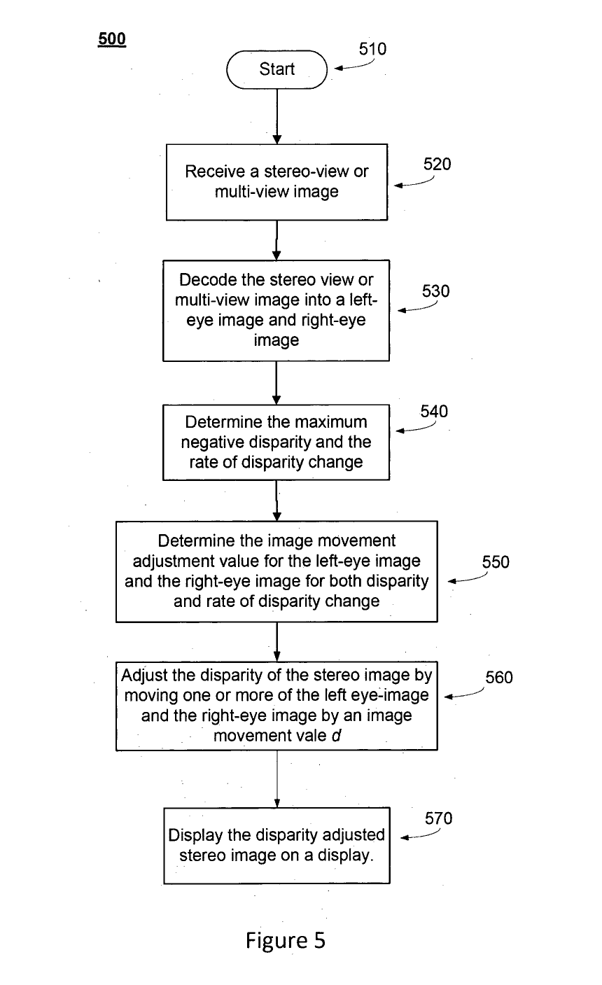

FIG. 5 is a flowchart of the image processing method 500 according to an embodiment of the present invention. After a start of the method 510, a stereo-view or multi-view image is received and decoded into the left-eye image and right-eye image at step 520. The stereo-view or multi-view image can be a three dimensional (3D) image in the form of either a signal or equivalent digital data. Step 520 can be performed using the image receiver 402 of FIG. 4. The received stereo view or multi-view images are then decoded into a left eye image and a right eye image in step 530 which can be performed using the image decoder 404 of FIG. 4. Disparities between the left-eye image and the right-eye image are estimated and the maximum negative disparity of the received images is determined in step 540. Step 540 can be performed using the maximum disparity analyzer 406 of FIG. 4. The rate of image protrusion or rate of change in the disparity can also be calculated. Then the image movement value for both the left-eye image and the right-eye image is calculated at step 550 based on the maximum negative disparity of this image and last image, the user established maximum negative disparity threshold value, and the maximum protruding rate threshold value (user's disparity rate change limit). Step 550 can be performed using the disparity control value determinator 408 of FIG. 4.

Note that the system of FIG. 4 and the method 500 of FIG. 5 provide two kinds of adjustment. One is the control of the maximum negative disparity to be displayed to a viewer. The other is the control of the rate of change of maximum negative disparity presented to a viewer. If users set the maximum negative disparity threshold, then the control function of the maximum negative disparity will occur. If users set the maximum protruding rate threshold, then the control function of the rate of change of maximum negative disparity will occur. If users set both the maximum negative disparity threshold and the maximum protruding rate threshold, then both control functions will occur as described in the method 500. The actual image movement value is the greater of the two calculated values. For example, in one embodiment, when the maximum negative disparity Dₘ of any objects of a 3D image exceeds a maximum negative disparity threshold value Dt, an image movement value d₁ will be calculated by Equation (1). If the amount of the maximum negative disparity Dₘ increases too quickly compared with the amount of the maximum negative disparity of the last image whose disparity has been adjusted, an image movement value d₂ will be calculated by Equation (2). Then the actual image movement value d is determined as

d=max(d₁,d₂) Equation (4)

Therefore, the image is adjusted so that the maximum negative disparity of the image won't exceeds the maximum negative disparity threshold value Dₜ and the protruding rate of any objects of the image won't exceeds the maximum protruding rate threshold δ as well. After the image is adjusted, the value of the maximum negative disparity of the last adjusted image, D′, is updated by Equation (3).

Note that the maximum negative disparity threshold value and the maximum protruding rate threshold values are threshold values for comfortable viewing established by a user. The maximum negative disparity threshold value and the maximum protruding rate threshold value may be determined interactively via the user interface 410. User inputs are accepted by the disparity control value determiner 408 and are processed as parameters useful as threshold values for comfortable viewing by a user. The disparity control value determiner 408 uses these user threshold values as well as inputs of maximum disparity and rate of change of disparity of values determined from the maximum disparity analyzer 406 to determine an image movement value d. The left-eye image and the right-eye image are moved to the left and to the right based on the calculated image movement value, respectively, and the disparities between the left-eye image and the right-eye image are adjusted at step 560. Step 560 can be performed by the disparity adjuster 412 of FIG. 4. The disparity-adjusted left-eye image and right-eye image are output and displayed at step 570. The disparity adjuster 412 outputs the disparity adjusted stereo signal to the stereo display 414 for comfortable user viewing.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms (for example, a hardware apparatus, hardware and software apparatus, or a computer-readable media). An apparatus may be implemented in, for example, appropriate hardware, software, and firmware. The methods may be implemented in, for example; an apparatus such as, for example, a processor, which refers to any processing device, including, for example, a computer, a microprocessor, an integrated circuit, or a programmable logic device. Processing devices also include communication devices, such as, for example, computers, cell phones, portable/personal digital assistants (“PDAs”), and other devices that facilitate communication of information between end-users.

Additionally, the methods may be implemented by instructions being performed by a processor, and such instructions may be stored on a processor or computer-readable media such as, for example, an integrated circuit, a software carrier or other storage device such as, for example, a hard disk, a compact diskette, a random access memory (“RAM”), a read-only memory (“ROM”) or any other magnetic, optical, or solid state media. The instructions may form an application program tangibly embodied on a computer-readable medium such as any of the media listed above. As should be clear, a processor may include, as part of the processor unit, a computer-readable media having, for example, instructions for carrying out a process. The instructions, corresponding to the method of the present invention, when executed, can transform a general purpose computer into a specific machine that performs the methods of the present invention.

1. An image processing apparatus comprising:
an image receiver and decoder to receive three dimensional (3D) image and decode the received 3D image into a left eye image and a right eye image;
a disparity analyzer to determine a maximum disparity and a rate of disparity change between the left eye image and the right eye image;
a disparity control value determiner to determine a disparity adjustment value based on the maximum disparity, the rate of disparity change, and threshold values;
a disparity adjuster to adjust the received left eye image and the received right eye image according to the disparity adjustment; and
an output from the disparity adjuster to drive a display using the adjusted left eye image and right eye image.

2. The apparatus of claim 1, further comprising a user interface which interactively is used to determine a maximum negative disparity threshold value.

3. The apparatus of claim 2, wherein the user interface also interactively determines a maximum protruding rate threshold value.

4. The apparatus of claim 1, wherein the disparity control value determiner produces a disparity adjustment value to control the maximum negative disparity if the maximum negative disparity threshold value is exceeded.

5. The apparatus of claim 1, wherein the disparity control value determiner produces a disparity adjustment value to control the rate of change of disparity if the maximum protruding rate threshold value is exceeded.

6. The apparatus according to claim 1, wherein the disparity adjuster adjusts the received left eye image and the received right eye image based on a maximum negative disparity threshold value and a maximum protruding rate threshold value.

7. The apparatus according to claim 1, further comprising a stereo 3D image display device for viewing the adjusted left eye image and right eye image.

8. A method performed by an image processing system, the method comprising:
receiving data for a three dimensional (3D) image;
decoding the 3D image into a left eye image and a right eye image;
determining, using at least one processor, a maximum disparity and a rate of disparity change of the decoded 3D image;
determining an image movement value and adjusting the left eye image and the right eye image using the maximum disparity and rate of disparity change in relation to at least one threshold value;
adjusting the left eye image and right eye image using the image movement value; and
displaying the adjusted left eye image and right eye image to a viewer on a 3D display device.

9. The method of claim 8, wherein the step of determining an image movement value includes a comparison of a maximum negative disparity threshold value and a maximum protruding rate threshold value with the maximum disparity and the rate of disparity change.

10. The method of claim 9, wherein if the maximum negative disparity threshold value is exceeded, then the image is adjusted so that the maximum negative disparity of the image will not exceed the maximum negative disparity threshold value.

11. The method of claim 9, wherein if the maximum protruding rate threshold value is exceeded, then the rate of change of the disparity is adjusted so that it will not exceed the maximum protruding rate threshold value.

12. The method of claim 9, wherein the maximum negative disparity threshold value and the maximum protruding rate threshold value are threshold values determined from a viewer.
